(19) United States
(12) Patent Application Publication
(10) Pub. No.: US 2026/0167455 A1
(43) Pub. Date: Jun. 18, 2026

(54) AN ACTUATING DEVICE FOR ACTUATING AN ELECTRIC DEVICE AND A METHOD OF ACTUATING AN ELECTRIC DEVICE

(71) Applicant: Logistics and Supply Chain MultiTech R&D Centre Limited, Pokfulam (HK)

(72) Inventors: Hong Man Wong, Pokfulam (HK); King Sau Wong, Pokfulam (HK)

(21) Appl. No.: 18/983,747

(22) Filed: Dec. 17, 2024

(51) Int. Cl. B66B 1/52; B66B 3/00; G05D 1/656; G05D 107/60; H01F 7/16; H04B 5/40

(52) U.S. Cl. CPC B66B 1/52; B66B 3/002; G05D 1/656; H01F 7/16; H04B 5/40; B66B 2201/103; B66B 2201/232; B66B 2201/4615; B66B 2201/4638; B66B 2201/4653; G05D 2107/60

(57) ABSTRACT

An actuating device for actuating an electric device includes: an actuator arranged to interact with a control panel of the electric device thereby actuating a function of the electric device; a wireless communication module arranged to receive a signal input associated with actuating a function of the electric device; and a control module arranged to generate a signal output to the actuator thereby commanding the actuator to interact with the control panel so as to actuate a function of the electric device. Disclosed also is a method of actuating an electric device.

### TECHNICAL FIELD

The invention relates to an actuating device for actuating an electric device and a method of actuating an electric device, although not exclusively, to an actuating device for actuating a function of an electric device and a method of actuating a function of the electric device.

### BACKGROUND

Lift system, also known as elevator, is movable in a vertical manner to carry passengers or freight between the levels of a multistory building. Most modern lift systems are propelled by electric motors, with the aid of a counterweight, through a system of cables and pulleys.

Wireless communication is widely adopted in the remote control of electric devices such as home appliances. However, due to the safety regulation, some countries do not allow lift system to communicate with other system through wireless communication.

### SUMMARY OF THE INVENTION

In accordance with a first aspect of the present invention, there is provided an actuating device for actuating an electric device, comprising:
an actuator arranged to interact with a control panel of the electric device thereby actuating a function of the electric device;
a wireless communication module arranged to receive a signal input associated with actuating a function of the electric device; and
a control module arranged to generate a signal output to the actuator thereby commanding the actuator to interact with the control panel so as to actuate a function of the electric device.

In accordance with the first aspect, further comprising an attachment for attaching the robotic device to the control panel of the electric device whereby the actuator is proximate to a button on the control panel and actuate the button upon commanded by the control module.

In accordance with the first aspect, the robotic module further comprises a plurality of actuators each positioned proximate to a plurality of buttons on the control panel and arranged to actuate the corresponding button upon commanded by the control module.

In accordance with the first aspect, the actuator comprises an end-effector arranged to interact with the control panel.

In accordance with the first aspect, the actuator further comprises a linear actuator.

In accordance with the first aspect, the actuator comprises a push button actuator arranged to exert a force onto the button of the control panel.

In accordance with the first aspect, the actuator further comprises a coil and a magnet relatively movable to each other for generating a force for actuating the button.

In accordance with the first aspect, the actuator further comprises a relay arranged to actuate the coil of the actuator in response to a command generated by the control module.

In accordance with the first aspect, further comprising a remote command module arranged to transmit the signal input associated with actuating a function of the electric device to the wireless communication module.

In accordance with the first aspect, the wireless communication module is arranged to receive the signal input associated with actuating a function of the electric device only when the remote command module is within a predetermined distance from the wireless communication module.

In accordance with the first aspect, further comprising a navigation module arranged to navigate the command module from a starting position to a destination so as to transmit the signal input at the destination.

In accordance with the first aspect, the command module is mounted on and navigate together with the navigation module.

In accordance with the first aspect, the control module is arranged to receive positional data associated the position of the command module.

In accordance with the first aspect, the control module is configured to receive a signal upon the command module reaches the destination whereby the actuator is commanded to actuate a button on the control panel of the electric device.

In accordance with the first aspect, the control module is configured to receive a signal associated with the successful actuation of a function of the electric device.

In accordance with the first aspect, further comprising an indicator arranged to generate a visual indication representing the successful actuation of a function of the electric device.

In accordance with the first aspect, the wireless communication module comprises a Bluetooth communication module.

In accordance with the first aspect, further comprising a rechargeable energy storage for the power supply of the actuator.

In accordance with the first aspect, the electric device comprises a lift and the control panel is a lift hall control panel.

In accordance with a second aspect of the present invention, there is provided a method of actuating an electric device, comprising the steps of:
receiving a signal input associated with actuating a function of the electric device;
generating a signal output to an actuator associated with actuating a function of the electric device; and
interacting the actuator with a control panel of the electric device thereby actuating a function of the electric device.

### BRIEF DESCRIPTION OF THE DRAWINGS

Embodiments of the present invention will now be described, by way of example, with reference to the accompanying drawings in which:

FIG. 1 is a schematic diagram showing an actuating device in accordance with one example embodiment of the present invention;

FIG. 2 is a perspective view showing an actuating device in accordance with another example embodiment of the present invention;

FIG. 3 is a perspective view showing an actuating device as shown in FIG. 2 attached to a control panel of a lift hall call panel;

FIG. 4 is a schematic diagram showing a BLE control system in accordance with one example embodiment of the present invention;

FIG. 5 is a schematic diagram showing the operation workflow of an actuating device in accordance with one example embodiment of the present invention;

FIG. 6 is a diagram showing a robot in communication with an actuating device in accordance with one example embodiment of the present invention;

FIG. 7 is a diagram showing a robot in communication with an actuating device in accordance with one example embodiment of the present invention;

FIG. 8 is a diagram showing a robot in communication with an actuating device in accordance with one example embodiment of the present invention; and

FIG. 9 is a diagram showing a robot in communication with an actuating device in accordance with one example embodiment of the present invention.

### DETAILED DESCRIPTION OF THE PREFERRED EMBODIMENTS

Without wishing to be bound by theories, the present inventors, through their own trials and researches, have discovered that a mobile robot needs a pragmatic method to communicate the lift for inter floor travelling.

To conduct desirable functions, robot needs to actuate buttons designed for humans accurately. While there are some traditional mechanical tools with vision, the performance is rather unstable. This is primarily contributed by the errors caused by mounting, calibration, localization, hardware inaccuracies etc.

The present invention provides a novel device that can press the hall call button of a lift while communicate with a robot. In particular, the device may include an attachable device for receiving request from a robot and button pressing through a wireless communication protocol. The interaction of the robot with the panel may be achieved by using BLE (Bluetooth) or other wireless communication method. Accordingly, the present invention may offer a novel wireless communication solution for operating the lift call at a low voltage and low latency while delivering precise action.

In one example embodiment of the present invention, there is provided smart fingers for robots to ride lifts. To realize lift hall call button actuation via wireless communication in a conventional lift hall call panel, the present invention may provide a small module design which is possible to be install on various lift panel with different configurations and number of push buttons with a minimal adaption. Preferably, the present invention may include a Bluetooth communicate module for communicating with a control unit and a voice coil actuator to push the button for inter floor travelling without the involvement of a human lift operator.

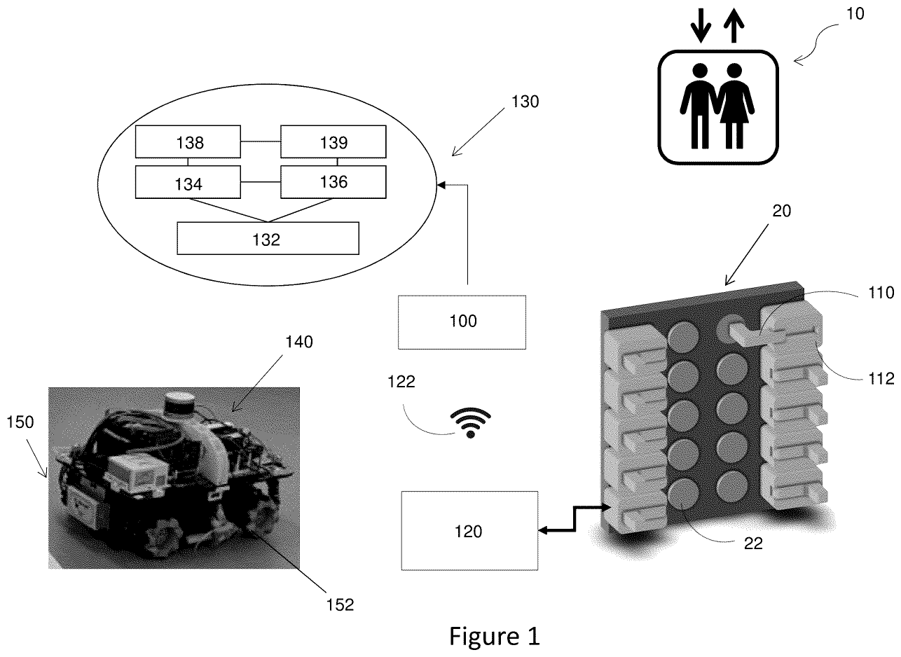

As show in FIG. 1, there is shown a conventional lift hall call panel 20 for operating a lift 10 between different levels of a building and calling the lift 10 to a specific level. The lift hall call panel 20 comprises a plurality of buttons 22 arranged on the panel 20 in an array and each button 22 corresponds to a function of the lift 10. For instance, the button 22 is a push button and may be pressed by the lift user for calling the lift 10 to a specific floor. The lift hall call panel 20 also comprises a LED display 30 to indicate the current floor level of the lift 10.

With reference to FIG. 1, there is shown an embodiment of an actuating device 100 for actuating an electric device 10, comprising: an actuator 110 arranged to interact with a control panel 20 of the electric device 10 thereby actuating a function of the electric device 10; a wireless communication module 120 arranged to receive a signal input associated with actuating a function of the electric device 10; and a control module 130 arranged to generate a signal output to the actuator 110 thereby commanding the actuator 110 to interact with the control panel 20 so as to actuate a function of the electric device 10.

For the purposes of this document, the term “electric device” includes any type of device operated by electricity, such as, but not limited to, lifts, elevators, patient transfer lifts, construction lifts, any transportation means which may transfer human or goods between multiple floors. The term “function” includes any type of function relevant to the operation of the electric device, such as, but not limited to, lift hall call button, door open button, door close button, alarm button.

As shown in FIG. 1 there is a shown a schematic diagram of an actuating device 100. The actuating device 100 can be embodied as a smart finger 100 in which a computing apparatus 130 is embedded. The smart finger 100 comprises two essential parts: an actuator 110 for interacting with the control panel 20 so as to call the lift 10 to a specific floor, and a wireless communication box 120 for the signal communication with the actuator 110 so as to generate a signal output to command the actuator 110 to actuate a lift button 22.

The actuator 110 can be embodied in the form of an end-effector which is operable to interact with the button 22 in response to one or more instructions from the computing apparatus 130. Specially, the end-effector can be attached to an end of the actuator 110 and interact with surrounding environments. For instance, the end-effector may have a magnetic pole which is opposite to the magnetic pole on the button 20 so that the magnetic induction may generate a magnetic force and trigger the button 22. The end-effector may also be embodied in other forms such as electric gripper, vacuum grippers, magnetic grippers, pneumatic gripper, needle grippers, or other gripper technologies. More advantageously, the end-effector may be connected to a further finger subassembly not shown in the Figures.

Importantly, the actuating device 100 may be provided in a compact modular arrangement. The modular design may further include an attachment which permits the multiple components such as the actuator 110 and the wireless communication box 120 to be attached onto the lift hall call panel 20. This may readily convert an isolated lift system into a lift system which may communicate with other wireless devices.

Preferably, the actuating device 100 may also include an indicator 112 proximate to the end-effector of the actuator 110 and the button 22 for displaying the pressing status of the button 22. If the button 22 is actuated by the actuator 110, the indicator 112 may glow to visually representing that the button 22 and the corresponding function has been successfully actuated by the actuator 110. When the actuated function is complete, the indicator 112 would no longer glow and the light on the indicator 112 may go off to visually represent that the function is no longer actuated.

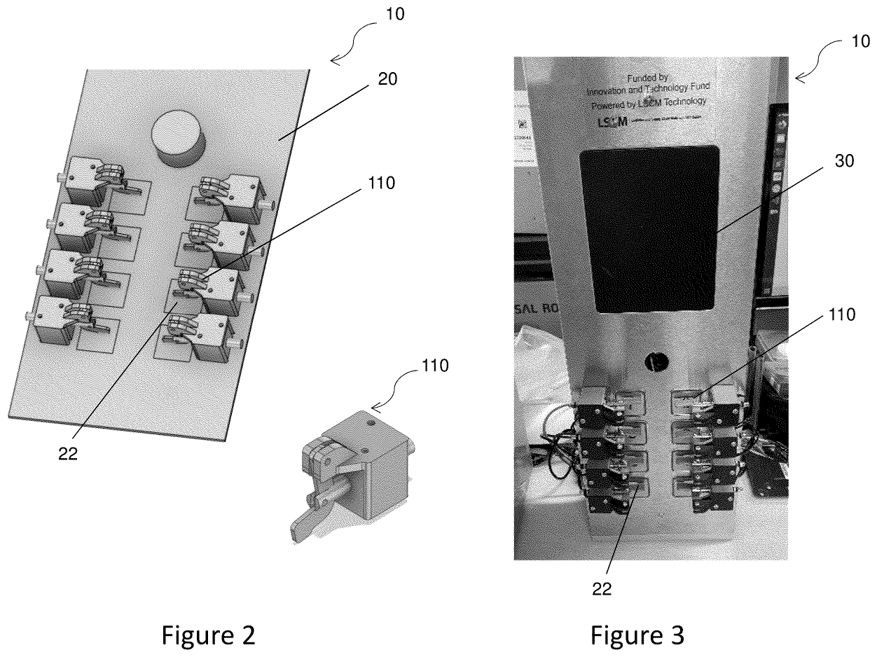

FIG. 2 shows the end-effector of the actuator 110 in the form of smart fingers in further details. In this example embodiment, the actuating device 100 may come with a plurality of fingers 110 each proximate to a corresponding button 22 on the control panel 20. The individual movement of these fingers 110 may be controlled by the computing apparatus 130 so as to interact with a corresponding button 22 on the control panel 20 and call the lift 10 to the correspond floor levels.

For instance, the end-effector may be embodied in the form of a push button actuator 110 to exert a pushing force onto the button 22 of the control panel 20 so as to actuate a function on the control panel 20. In this arrangement, the push button actuator 110 may be a linear actuator which may create a linear motion and generate a pushing force. The linear actuator may be a voice coil actuator 110 which includes a coil and a magnetic relatively movable to each other to generate the pushing force. The voice coil actuator 110 may be a moving coil actuator which includes a coil wound around a bobbin, made from many non-magnetic materials, that moves in and out of a permanent magnetic field assembly consisting of a steel housing with a concentric permanent magnet assembly in the middle. The voice coil actuator 110 may also be a moving magnet actuator where the coil is fixed and the magnet assembly moves. Alternatively, the push button actuator may also be a circular voice coil actuator which provides a circular motion through the relative movement between the coil and the magnet instead of a linear motion.

Optionally, there is also provided a sensing capability on the actuator 110. For instance, the actuator 110 may be a force compliant end-effector which allows the finger 110 to exert a pushing force on the button 22 while also sensing the resistance or reaction of the button 22 to the applied force and feedback to the computing apparatus 130. The force compliant end-effector may be either an active compliant end-effector or a passive end-effector.

Referring to FIG. 1 again, the actuating device 100 may comprise a computing apparatus 130 which includes suitable components necessary to receive, store and execute appropriate computer instructions. The computing apparatus 130 may be a main control unit such as Arduino Nano 33BLE board. The components may include a processing unit 132, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM) 134, random access memory (RAM) 136, and input/output devices such as disk drives 138, and a user interface 139 such as a dashboard. In this example embodiment, the processor 132 is configured to receive one or more signal inputs. For instance, the processor 132 is configured to receive various data e.g., one or more signal input from a remote command module 140 and a navigation module 150. The computing apparatus 130 may include instructions that may be included in ROM 134, RAM 136, or disk drives 138 and may be executed by the processing unit 132.

Essentially, the actuating device 100 may further comprise a wireless communication module 120 in wireless communication 122 with a command module 140. The wireless communication box 120 may include a Bluetooth module 120 e.g., Nordic nRF52840. The Bluetooth module has a low operating power and may be automatically shifted between sleep mode and on mode.

The actuating device 100 may further comprise a command module 140 for generating a signal input which is transmitted to the wireless communication module 120 via wireless communication with a low power consumption e.g., Bluetooth (BLE) communication method. The signal strength of the low energy Bluetooth signal transmitted from the command module 140 to the wireless communication module 120 may only be determined if the command module 140 is within a predetermined distance from the wireless communication module 120.

To adjust the position of the command module 140, there may also be provided a navigation module 150 for carrying the command module 140 so that the command module 140 may be navigated from a starting position remote from the wireless communication module 120 to a destination at which the command module 140 may send a signal so that the actuator 110 may actuate the button 22 on the control panel 20.

Preferably, the navigation module 150 may be embodied as a robot and further includes a mobile base 152 for carrying the command module 140 and other essential components of the navigation module 150. The command module 140 may be positioned externally and at an elevated position relative to the navigation module 150 without being obstructed.

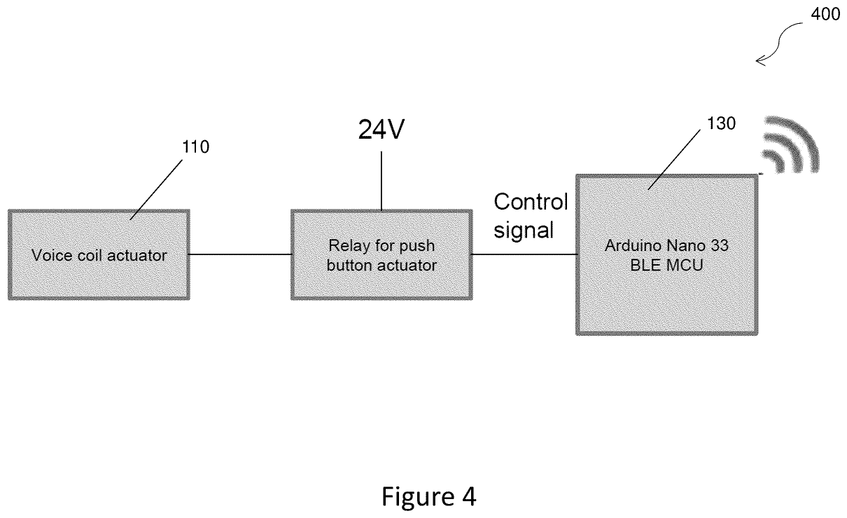

FIG. 4 shows the interaction between the voice coil actuator 110, the wireless communication module 120 and the control module 130 in a BLE control system design 400 in accordance with one example embodiment in further details.

In this configuration, the control module 130 and the voice coil actuator 110 are under two separate circuits. Once the wireless communication module 120 receives a signal from a remote command module 140, the control module 130 may issue a control signal to the actuator 110 which is a very small electric output.

Preferably, the push button actuator 110 further includes a relay in an operating voltage of e.g., 24V. If the required operating voltage is supplied to the relay, the relay is activated. To trigger the push button actuator 110, the control module 130 emits a control signal such that a 24V operating voltage is supplied to the relay and the push button actuator 110 is actuated to exert a push force on the button 22.

Advantageously, the BLE control system design 400 requires only a very low power consumption. For instance, the Bluetooth module 120 requires only a current draw of 0.4 μA in the sleep mode (deliverable<9 μA) and a current draw of 1.5 μA in the on mode (deliverable<30 mA) respectively. A single push button actuator 110 requires only a current draw of 0.20 A (deliverable<0.25 A). Assuming there would be a button press of 40 times per day and 1 second is needed for each press, there would be 0.0777 hour per week. In turn, the average current consumption per week with a 80% efficiency would be 0.2A×0.0777 hr×1.2=0.019 Ah (deliverable<1.75 Ah).

In one example embodiment, there is provided a set of eight push button actuators 110 for actuating eight corresponding buttons 22 on the control panel 20. One actuator 110 on and the other 7 actuators idle would require a current draw of 0.778A, while all eight actuators being idle would require a current draw of 0.078A. On the assumption that the set would be operated 8 hours per day (from deliverable) and there would be 40 button presses per day, the total power consumption of the eight actuators system per week would be 4.42 Ah. If a 60 Ah battery (from deliverable) is provided for the power supply, the eight actuators system can be used for 13.5 week (more than 3 weeks) for a single charge of the battery.

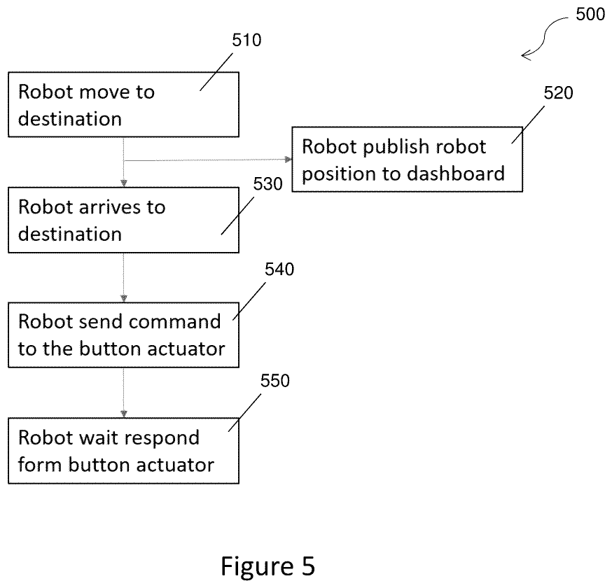

With reference to FIG. 5, there is shown an embodiment of a method of actuating an electric device 10, comprising the steps of: receiving a signal input associated with actuating a function of the electric device 10; generating a signal output to an actuator 110 associated with actuating a function of the electric device 10; and interacting the actuator 110 with a control panel 20 of the electric device 10 thereby actuating a function of the electric device 10.

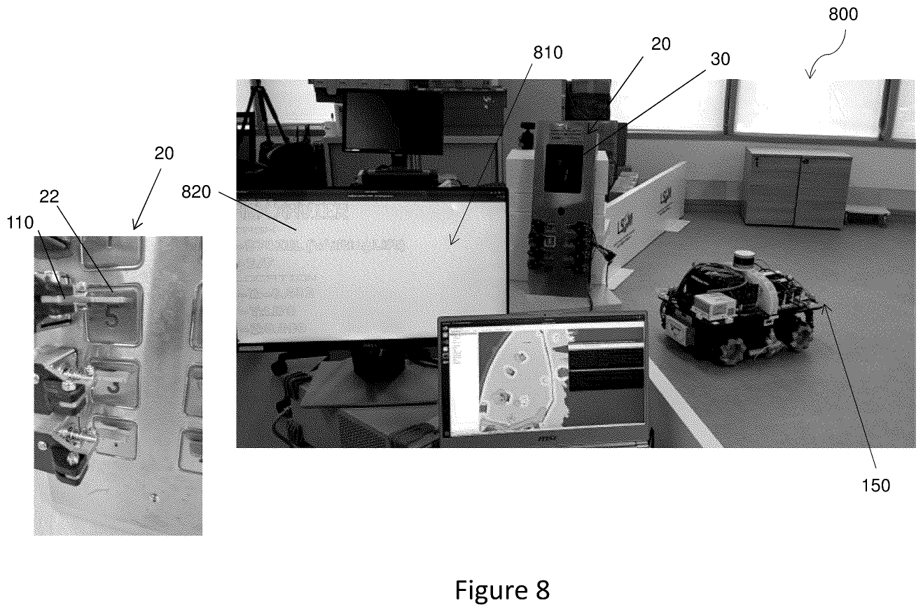

The operation mode of one example embodiment of the actuating device 100 will now be described with reference to FIGS. 5 to 9 in further details. In this example, the actuating device 100 is used in the lift call application within a building.

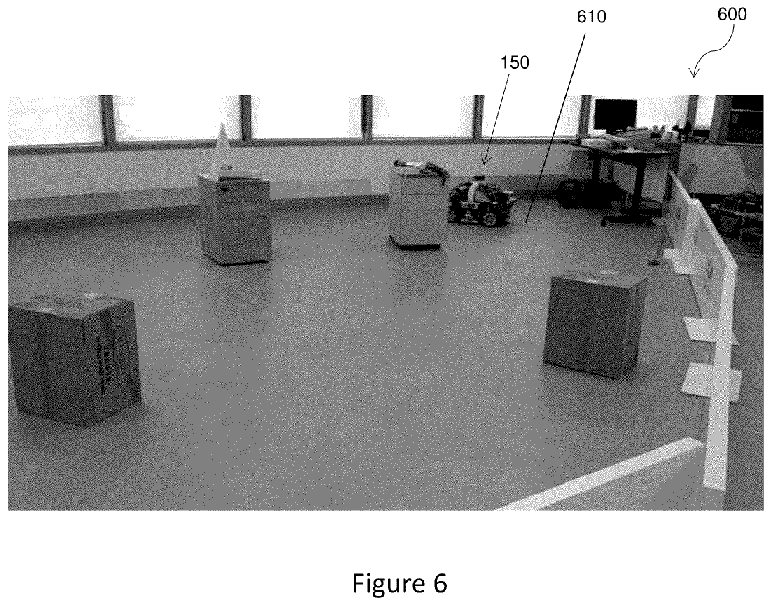

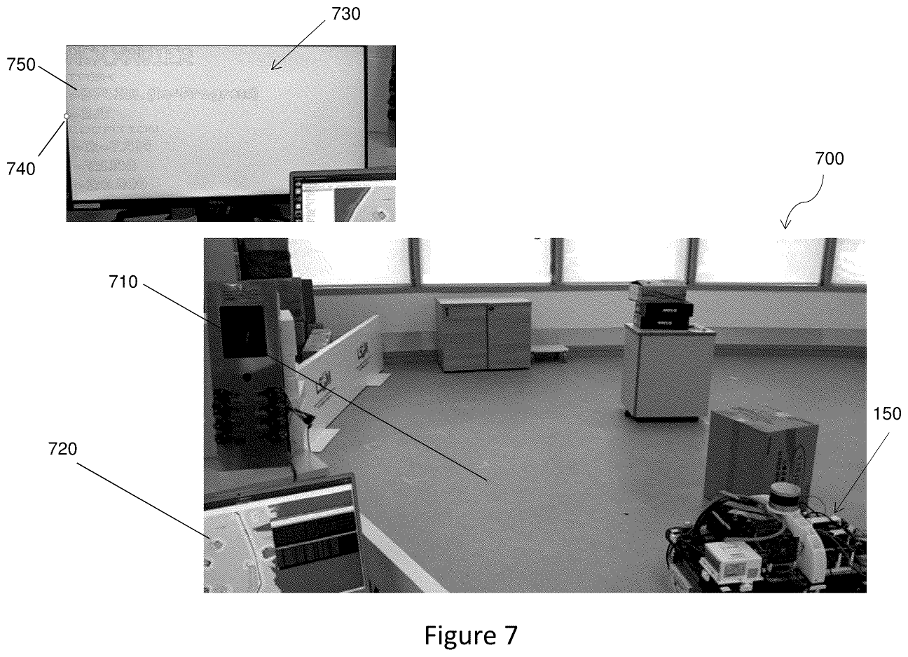

Referring to FIG. 5, the method 500 begins with step 510. Initially, the robot 150 together with the command module 140 navigate from a starting position 610 as shown in FIG. 6 to a destination 710 e.g., 1/F of a building as shown in FIG. 7. The environment associated with the navigation path is visualized on a robot screen 720 as shown in FIG. 7. During the navigation, the robot 150 may publish the robot position to a dashboard 730 as shown in FIG. 7 (step 520). The information associated with the position e.g., the current floor level of the robot 150 would be transmitted to the actuating device 100. If the information associated with the current floor level matches the destination floor 740 and the destination ID 750 shown on the dashboard 730, the robot 150 is deemed to arrive to the destination 514 (step 530).

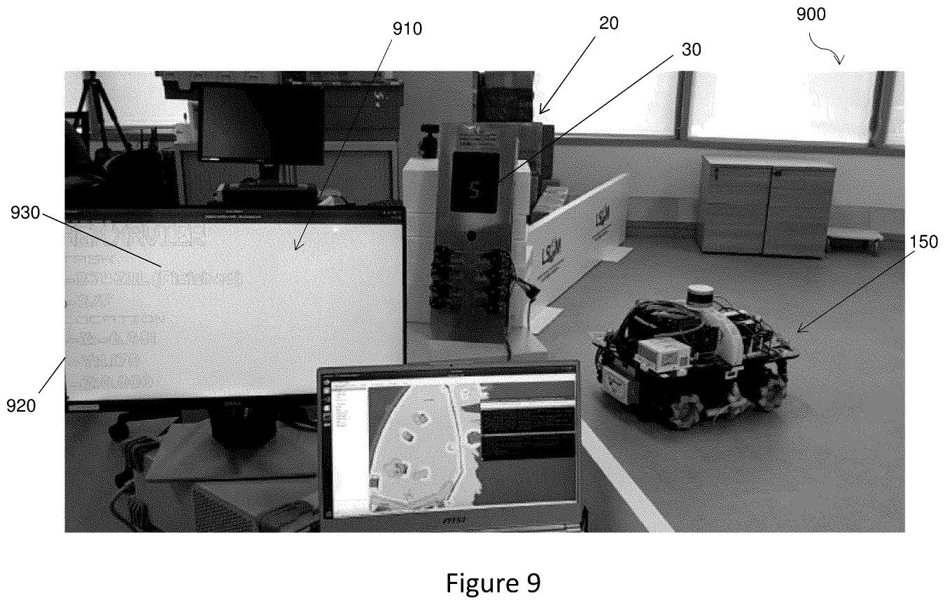

Method 500 may then proceed to step 540 where the robot 150 may send a command to the button actuator 110. For instance, the robot 150 may receive an instruction to call the lift to 5/F. The waiting lift status 820 is published to the dashboard 810. The remote command module 140 may send a command to the wireless communication module 120 so as to command the button actuator 110. In response to the command by the remote command module 140, the actuator 110 may push the button 22 on the control panel 20 to call the lift 10 to 5/F. Finally, the robot 150 would wait for the response from the button actuator 110 (step 550). The button actuator 110 would be actuated for a predetermined time period and the button actuator 110 upon actuated may provide feedback to the actuating device 100. The lift 10 would then travel to 5/F in response to the actuation of the button 22. The location coordinate 920 and the finished status 930 of the robot 150 would be subsequently shown on the dashboard 910 as shown in FIG. 9 when the lift arrives 5/F. Once the lift 10 arrives the 5^{th} floor, method 500 is complete and ends there. To call the lift to another floor, the robot 150 may be instructed to repeat steps 510 to 550 again accordingly.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, standalone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An actuating device for actuating an electric device, comprising:
an actuator arranged to interact with a control panel of the electric device thereby actuating a function of the electric device;
a wireless communication module arranged to receive a signal input associated with actuating a function of the electric device; and
a control module arranged to generate a signal output to the actuator thereby commanding the actuator to interact with the control panel so as to actuate a function of the electric device.

2. An actuating device in accordance with claim 1, further comprising an attachment for attaching the robotic device to the control panel of the electric device whereby the actuator is proximate to a button on the control panel and actuate the button upon commanded by the control module.

3. An actuating device in accordance with claim 1, wherein the robotic module further comprises a plurality of actuators each positioned proximate to a plurality of buttons on the control panel and arranged to actuate the corresponding button upon commanded by the control module.

4. An actuating device in accordance with claim 1, wherein the actuator comprises an end-effector arranged to interact with the control panel.

5. An actuating device in accordance with claim 1, wherein the actuator further comprises a linear actuator.

6. An actuating device in accordance with claim 1, wherein the actuator comprises a push button actuator arranged to exert a force onto the button of the control panel.

7. An actuating device in accordance with claim 1, wherein the actuator further comprises a coil and a magnet relatively movable to each other for generating a force for actuating the button.

8. An actuating device in accordance with claim 7, wherein the actuator further comprises a relay arranged to actuate the coil of the actuator in response to a command generated by the control module.

9. An actuating device in accordance with claim 1, further comprising a remote command module arranged to transmit the signal input associated with actuating a function of the electric device to the wireless communication module.

10. An actuating device in accordance with claim 9, wherein the wireless communication module is arranged to receive the signal input associated with actuating a function of the electric device only when the remote command module is within a predetermined distance from the wireless communication module.

11. An actuating device in accordance with claim 9, further comprising a navigation module arranged to navigate the command module from a starting position to a destination so as to transmit the signal input at the destination.

12. An actuating device in accordance with claim 11, wherein the command module is mounted on and navigate together with the navigation module.

13. An actuating device in accordance with claim 11, wherein the control module is arranged to receive positional data associated the position of the command module.

14. An actuating device in accordance with claim 11, wherein the control module is configured to receive a signal upon the command module reaches the destination whereby the actuator is commanded to actuate a button on the control panel of the electric device.

15. An actuating device in accordance with claim 1, wherein the control module is configured to receive a signal associated with the successful actuation of a function of the electric device.

16. An actuating device in accordance with claim 15, further comprising an indicator arranged to generate a visual indication representing the successful actuation of a function of the electric device.

17. An actuating device in accordance with claim 1, wherein the wireless communication module comprises a Bluetooth communication module.

18. An actuating device in accordance with claim 1, further comprising a rechargeable energy storage for the power supply of the actuator.

19. An actuating device in accordance with claim 1, wherein the electric device comprises a lift and the control panel is a lift hall control panel.

20. A method of actuating an electric device, comprising the steps of:
receiving a signal input associated with actuating a function of the electric device;
generating a signal output to an actuator associated with actuating a function of the electric device; and
interacting the actuator with a control panel of the electric device thereby actuating a function of the electric device.
